(19) United States
(12) Patent Application Publication
(10) Pub. No.: US 2022/0293954 A1
(43) Pub. Date: Sep. 15, 2022

(54) NEGATIVE ELECTRODE PLATE, ELECTROCHEMICAL DEVICE, AND ELECTRONIC DEVICE

(71) Applicants: Ningde Amperex Technology Limited, Ningde City (CN); Dongguan Amperex Technology Limited, Dongguan City (CN)

(72) Inventor: Zhenhe Sun, Ningde City (CN)

(73) Assignees: Ningde Amperex Technology Limited, Ningde City (CN); Dongguan Amperex Technology Limited, Dongguan City (CN)

(21) Appl. No.: 17/710,161

(22) Filed: Mar. 31, 2022

Related U.S. Application Data
(63) Continuation of application No. PCT/CN2021/079812, filed on Mar. 9, 2021.

(51) Int. Cl. H01M 4/62; H01M 10/0525; H01M 10/0567; H01M 4/38; H01M 4/134

(52) U.S. Cl. CPC H01M 4/625; H01M 10/0525; H01M 10/0567; H01M 4/386; H01M 4/134; H01M 2300/0025; H01M 2004/027

(57) ABSTRACT

An electronic device includes an electrochemical device. The electrochemical device includes a negative electrode plate, and the negative electrode plate includes a negative current collector, a bonding layer, and a negative active material layer. The bonding layer is disposed between the negative current collector and the negative active material layer. The bonding layer includes a copolymer. Monomers that form the copolymer include at least a propylene monomer. The bonding layer is disposed between the negative current collector and the negative active material layer, the bonding layer includes a copolymer, and the monomers that form the copolymer include at least a propylene monomer, thereby improving the bonding between the negative current collector and the negative active material layer, enhancing interface stability of the corresponding electrochemical device during cycling, and improving cycle performance of the electrochemical device.

### CROSS REFERENCE TO THE RELATED APPLICATIONS

This application claims priority to Patent Application No. PCT/CN2021/079812, filed on Mar. 9, 2021, the whole disclosure of which is incorporated herein by reference.

### TECHNICAL FIELD

This application relates to the field of electrochemical energy storage, and in particular, to a negative electrode plate, an electrochemical device, and an electronic device.

### BACKGROUND

With the development and progress of electrochemical devices (such as a lithium-ion battery), higher requirements have been posed on the cycle performance of the electrochemical devices. Although the current technology for improving the electrochemical devices can improve the cycle performance of the electrochemical devices to some extent, the improvement is still unsatisfactory and more improvements are expected.

### SUMMARY

An embodiment of this application provides a negative electrode plate. The negative electrode plate includes: a negative current collector; a bonding layer, including a copolymer, where monomers that form the copolymer include at least a propylene monomer; and a negative active material layer, where the bonding layer is disposed between the negative current collector and the negative active material layer.

In some embodiments, 0.1≤X/K≤0.75, where a weight of the bonding layer per unit area of the negative current collector is X×10⁻⁴ mg/mm², and a bonding force between the negative current collector and the bonding layer is K N/m. In some embodiments, 1≤X≤30, and preferably, 1≤X≤10. In some embodiments, 1≤K≤100.

In some embodiments, 3≤X/C≤350, where a weight of the bonding layer per unit area of the negative current collector is X×10⁻⁴ mg/mm², and a capacity per unit area of the negative active material layer is C mAh/mm². In some embodiments, 3≤X/C≤100.

In some embodiments, 0.2≤K/(R₁−R₂)≤100, where a bonding force between the negative current collector and the bonding layer is K N/m, a total resistance of the bonding layer and the negative current collector is R₁ mΩ·mm², and a resistance of the negative current collector is R₂ mΩ·mm².

In some embodiments, the propylene monomer accounts for 30 mol % to 95 mol % of an aggregate of the monomers that form the copolymer. In some embodiments, the copolymer is particles, and an average particle diameter of the particles is 50 μm or less. In some embodiments, a softening point of the copolymer is 70° C. to 90° C. In some embodiments, an isotacticity of the copolymer is 35% to 80%. In some embodiments, a weight-average molecular weight of the copolymer is 500 to 1,000,000. In some embodiments, a swelling degree of the copolymer in diethyl carbonate is 40% or less. In some embodiments, the copolymer includes a polar functional group. The polar functional group includes at least one selected from the group consisting of a hydroxyl group, an amino group, a carboxyl group and an ester group. In some embodiments, the monomers that form the copolymer further include at least one selected from the group consisting of ethylene, vinylidene difluoride, chloroethylene, butadiene, isoprene, styrene, acrylonitrile, ethylene oxide, propylene oxide, acrylate, vinyl acetate and caprolactone.

In some embodiments, the negative active material layer includes a silicon-based material. A percentage of a weight of the silicon-based material in a total weight of the negative active material layer is Y %, and 5≤Y≤95. In some embodiments, the bonding layer further includes a conductive agent. The conductive agent includes at least one selected from the group consisting of carbon black, Ketjen black, graphene, carbon nanotubes and carbon fiber.

Another embodiment of this application provides an electrochemical device, including: a positive electrode plate; a negative electrode plate; and a separator. The separator is disposed between the positive electrode plate and the negative electrode plate. The negative electrode plate is any one of the negative electrode plates described above. In some embodiments, the electrochemical device further includes an electrolytic solution. The electrolytic solution includes at least one of the following compounds:

(a) propionate;

(b) an organic compound containing a cyano group;

(c) lithium difluorophosphate; and

(d)

[symbol]

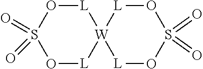

where

W is selected from

[symbol]

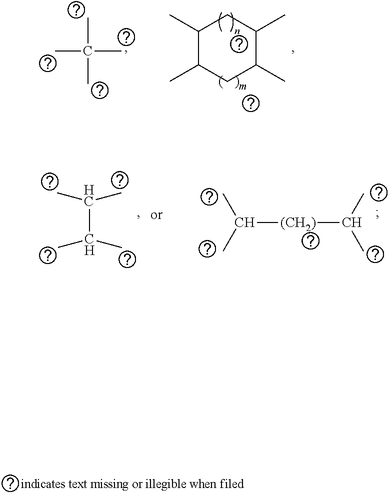

L is selected from a single bond or a methylene group;

m is an integer from 1 to 4;

n is an integer from 0 to 2; and

p is an integer from 0 to 6.

An embodiment of this application further provides an electronic device, including the electrochemical device.

In the embodiments of this application, the bonding layer is disposed between the negative current collector and the negative active material layer, the bonding layer includes a copolymer, and the monomers that form the copolymer include at least a propylene monomer, thereby improving the bonding between the negative current collector and the negative active material layer, enhancing interface stability of the corresponding electrochemical device during cycling, and improving cycle performance of the electrochemical device.

### DETAILED DESCRIPTION

The following embodiments enable a person skilled in the art to understand this application more comprehensively, but without limiting this application in any way.

In some embodiments, this application provides a negative electrode plate. The negative electrode plate may include a negative current collector, a bonding layer, and a negative active material layer. The bonding layer is located between the negative current collector and the negative active material layer. The negative active material layer and the bonding layer may be disposed on one side or both sides of the negative current collector.

In some embodiments, the bonding layer includes a copolymer. The monomers that form the copolymer include at least a propylene monomer. The bonding layer is disposed between the negative current collector and the negative active material layer, the bonding layer includes the copolymer, and the monomers that form the copolymer include at least a propylene monomer, thereby improving the bonding between the negative current collector and the negative active material layer, enhancing interface stability of the electrochemical device containing the negative electrode plate during cycling, and improving cycle performance of the electrochemical device.

In some embodiments, 0.1≤X/K≤0.75

where, a weight of the bonding layer per unit area of the negative current collector is X×10⁻⁴ mg/mm², and a bonding force between the negative current collector and the bonding layer is K N/m. X/K reflects the bonding performance of the bonding layer. When X/K is less than 0.1, it indicates that the bonding layer is highly adhesive, and the bonding layer is prone to cause fracture of the negative current collector or other consequences as the negative active material layer expands and contracts during cycling, because such a bonding layer lacks ductility. When X/K is greater than 0.75, it indicates that the bonding performance of the bonding layer is low, and it is necessary to increase a coating area of the bonding layer or increase a coating amount to increase the bonding strength between the negative current collector and the bonding layer, thereby adversely affecting the energy density of the electrochemical device. In some embodiments, 0.165≤X/K≤0.75. In some embodiments, 0.5≤X/K≤0.75. In this way, the value of X is avoided being too large on the basis of ensuring an appropriate bonding force between the bonding layer and the negative current collector, thereby minimizing adverse effects on the energy density of the electrochemical device.

In some embodiments, 1≤X≤30. If the value of X is smaller than 1, the weight of the bonding layer per unit area may be too small, thereby being adverse to the exertion of the bonding performance of the bonding layer. If the value of X is larger than 30, the energy density of the electrochemical device is adversely affected. In some embodiments, 1≤X≤10. In this way, the adverse effects on the energy density of the electrochemical device is minimized on the basis of ensuring high bonding performance of the bonding layer. In some embodiments, 1≤K≤100. If the value of K is too small, adverse effects are caused to the bonding between the negative current collector and the bonding layer. If the value of K is relatively large, the value of X usually needs to be large, thereby adversely affecting the energy density of the electrochemical device.

In some embodiments, 3≤X/C≤350

where, the weight of the bonding layer per unit area of the negative current collector is X×10⁻⁴ mg/mm², and the capacity per unit area of the negative active material layer is C mAh/mm². The higher the capacity C per unit area of the negative active material layer, the larger the coating amount of the negative active material. In this case, the volume change caused by the intercalation and deintercalation of lithium ions is also great, and therefore, the weight X of the bonding layer per unit area is increased correspondingly to increase the bonding force between the bonding layer and the negative current collector. When the value of X/C is smaller than 3, the bonding force between the bonding layer and the negative current collector may be small, which may result in detachment. If the value of X/C is larger than 350, it indicates that the weight of the bonding layer per unit area may be too high, thereby adversely affecting the energy density of the electrochemical device. In some embodiments, 3≤X/C≤100. By setting the value range to satisfy 3≤X/C≤100, this application minimizes the adverse effects on the energy density of the electrochemical device on the basis of ensuring appropriate bonding between the bonding layer and the negative current collector.

In some embodiments, 0.2≤K/(R₁−R₂)≤100

In the relational expression above, the bonding force between the negative current collector and the bonding layer is K N/m, the total resistance of the bonding layer and the negative current collector is R₁ mΩ·mm², and the resistance of the negative current collector is R₂ mΩ·mm². R₁−R₂ corresponds to the resistance of the bonding layer. If K/(R₁−R₂) is too small, for example, smaller than 0.2, it indicates that the bonding performance of the bonding layer is low, and the resistance is high. On the one hand, the low bonding performance is adverse to the bonding between the bonding layer and the negative current collector. On the other hand, the high resistance is adverse to improving the rate performance of the electrochemical device. If K/(R₁−R₂) is too large, for example, larger than 100, the bonding force between the bonding layer and the negative current collector needs to be increase, and the resistance of the bonding layer also needs to be reduced. Generally, in order to increase the bonding force between the bonding layer and the negative current collector, it is necessary to increase the content of the adhesive material in the bonding layer; in order to reduce the resistance of the bonding layer, it is necessary to increase the content of the conductive agent in the bonding layer. A mutual check and balance relationship exists between the two parameters to some extent, and it is difficult to make K/(R₁−R₂) be larger than 100.

In some embodiments, the propylene monomer accounts for 30 mol % to 95 mol % of an aggregate of the monomers that form the copolymer. If the molar percent of the propylene monomer is too low, for example, lower than 30%, adverse effects are caused to the exertion of the high bonding performance of the copolymer. In some embodiments, the copolymer is particles, and an average particle diameter of the particles is 50 μm or less. If the average particle diameter of the copolymer particles is too large, for example, larger than 50 μm, on the one hand, the conductivity of the bonder layer is adversely affected. On the other hand, the specific surface area of the copolymer particles is made to be too small, thereby being adverse to the exertion of the bonding effect of the copolymer in the bonding layer. In some embodiments, a softening point of the copolymer is 70° C. to 90° C. If the softening point of the copolymer is too low, for example, lower than 70° C., the copolymer is hardly stable in structure, and is prone to soften. If the softening point of the copolymer is too high, for example, higher than 90° C., the processing of the bonding layer is inconvenient, and the processing cost of the bonding layer increases.

In some embodiments, an isotacticity of the copolymer is 35% to 80%. The higher the isotacticity of the copolymer, the higher the crystallinity of the copolymer, and the higher the performance indicators such as melting point, tensile strength, flexural modulus, and anti-impact strength. Therefore, if the isotacticity of the copolymer is too low, for example, lower than 35%, the performance indicators such as the tensile strength of the copolymer will be low. However, if the isotacticity of the copolymer is too high, for example, higher than 80%, the performance indicators such as the tensile strength of the copolymer will be too high, the ductility is insufficient, and the negative current collector is prone to fracture and other consequences during cycling.

In some embodiments, a weight-average molecular weight of the copolymer is 500 to 1,000,000. If the weight-average molecular weight of the copolymer is too low, the performance indicators such as the tensile strength of the copolymer will be low. If the weight-average molecular weight of the copolymer is too high, adverse effects will be caused to the processing of the copolymer. In some embodiments, a swelling degree of the copolymer in diethyl carbonate is 40% or less. If the swelling degree of the copolymer in diethyl carbonate is too high, the copolymer will expand in volume greatly during cycling of the electrochemical device, thereby being adverse to the structural stability of the bonding layer and being at risk of detachment.

In some embodiments, the copolymer includes a polar functional group. The polar functional group includes at least one selected from the group consisting of a hydroxyl group, an amino group, a carboxyl group and an ester group. By containing such polar functional groups, the copolymer can interact with other materials in the bonding layer or with the negative current collector more efficiently, thereby enhancing the bonding performance of the bonding layer. In some embodiments, the monomers that form the copolymer further include at least one selected from the group consisting of ethylene, vinylidene difluoride, chloroethylene, butadiene, isoprene, styrene, acrylonitrile, ethylene oxide, propylene oxide, acrylate, vinyl acetate and caprolactone.

In some embodiments, the bonding layer further includes a conductive agent. The conductive agent includes at least one selected from the group consisting of carbon black, Ketjen black, graphene, carbon nanotubes and carbon fiber. The conductive agent contained in the bonding layer increases the conductivity of the bonding layer, and thereby improves the direct-current resistance of the electrochemical device. In some embodiments, a weight percent of the conductive agent in the bonding layer is 50% to 95%. In some embodiments, a thickness of the bonding layer may be 1 μm to 50 μm. The values enumerated herein are merely exemplary, and any other appropriate thicknesses may be adopted.

In some embodiments, the negative active material layer includes a silicon-based material. A percentage of a weight of the silicon-based material in a total weight of the negative active material layer is Y %, and 5≤Y≤95. If the weight percent of the silicon-based material in the negative active material layer is too low, for example, lower than 5%, the effect of increasing the energy density of the electrochemical device by using the silicon-based material is limited. On the other hand, if the weight percent of the silicon-based material in the negative active material layer is too high, for example, higher than 95%, the negative active material layer may cause large volume expansion due to the high content of the silicon-based material. This is adverse to stability of a solid electrolyte interface (SEI) film of the negative electrode, and may cause excessive consumption of the electrolytic solution. In some embodiments, the silicon-based material may include at least one of Si, SiOₓ, SiO₂, SiC, Li₂SiO₅, Li₂SiO₃, Li₄SiO₄, a silicon alloy, where 0.6≤x≤1.5. In some embodiments, 0.1≤W/Y≤50, where W represents the resistance (unit: mΩ·mm²) of the negative active material layer. A percentage of the weight of the silicon-based material in the total weight of the negative active material layer is Y %. When W/Y is smaller than 0.1, it indicates that the weight percent of the silicon-based material in the negative active material layer may be too high, and may cause large volume expansion during cycling of the electrochemical device to result in peeling of the negative active material layer. If W/Y is larger than 50, it indicates that the resistance of the negative active material layer is relatively high and the weight percent of the silicon-based material is relatively low. The high resistance of the negative active material layer is adverse to improving the rate performance of the electrochemical device. The low weight percent of the silicon-based material is adverse to improving the energy density of the electrochemical device. In some embodiments, the silicon-based material includes silicon element and oxygen element, and the oxygen content in the silicon-based material falls within a range of 3 atomic percent to 40 atomic percent. When the oxygen content falls within the above range, the capacity of the electrochemical device is relatively high, and high stability can be maintained during charge and discharge cycles.

In some embodiments, the negative active material layer may further include a conductive agent and a binder. The weight percent of the binder in the negative active material layer may be 0.5% to 10%. The weight percent of the conductive agent in the negative active material layer may be 0.5% to 10%. In some embodiments, the binder in the negative active material layer may include at least one of carboxymethyl cellulose, polyacrylic acid, polyvinylpyrrolidone, polyaniline, polyimide, polyamideimide, polysiloxane, polystyrene butadiene rubber, epoxy resin, polyester resin, polyurethane resin, or polyfluorene. In some embodiments, the conductive agent in the negative active material layer may include at least one of single-walled carbon nanotubes, multi-walled carbon nanotubes, carbon fiber, conductive carbon black, acetylene black, Ketjen black, conductive graphite, or graphene. Understandably, the material types and the weight percents of the conductive agent and the binder in the negative active material layer, which are enumerated above, are merely exemplary. Other appropriate materials and weight percents may be adopted instead.

In some embodiments, the negative current collector of the negative electrode plate may be at least one of a copper foil, a nickel foil, or a carbon-based current collector. In some embodiments, the compacted density of the negative active material layer of the negative electrode plate may be 1.0 g/cm³ to 2.2 g/cm³. If the compacted density of the negative active material layer is too low, the volumetric energy density of the electrochemical device is impaired. If the compacted density of the negative active material layer is too high, the passage of lithium ions is adversely affected, the polarization increases, the electrochemical performance is adversely affected, and the electrochemical device is prone to lithium plating during charging.

Some embodiments of this application provide an electrochemical device. The electrochemical device includes an electrode assembly. The electrode assembly includes a positive electrode plate, a negative electrode plate, and a separator disposed between the positive electrode plate and the negative electrode plate. The negative electrode plate is any one of the negative electrode plates described above.

In some embodiments, the positive electrode plate includes a positive current collector and a positive active material layer disposed on the positive current collector. The positive active material layer is disposed on one side or both sides of the positive current collector. In some embodiments, the positive current collector may be an aluminum foil, or may be another positive current collector commonly used in the art. In some embodiments, the thickness of the positive current collector may be 1 μm to 50 μm. In some embodiments, the positive active material layer may be coated on merely a local region of the positive current collector. In some embodiments, the thickness of the positive active material layer may be 10 μm to 500 μm. In some embodiments, the positive active material layer includes a positive active material. In some embodiments, the positive active material may include at least one of lithium cobalt oxide, lithium manganese oxide, lithium iron phosphate, lithium iron manganese phosphate, lithium-rich manganese-based material, lithium nickel cobalt manganese oxide, lithium nickel cobalt aluminum oxide, or lithium nickel manganese oxide. In some embodiments, the positive active material layer further includes a binder and a conductive agent. In some embodiments, the binder in the positive active material layer may include at least one of polyvinylidene fluoride, a vinylidene fluoride-hexafluoropropylene copolymer, a styrene-acrylate copolymer, styrene-butadiene copolymer, polyamide, polyacrylonitrile, polyacrylic ester, polyacrylic acid, sodium polyacrylate, sodium carboxymethyl cellulose, polyvinyl acetate, polyvinylpyrrolidone, polyvinyl ether, poly methyl methacrylate, polytetrafluoroethylene, or polyhexafluoropropylene. In some embodiments, the conductive agent in the positive active material layer may include at least one of conductive carbon black, Ketjen black, graphite flakes, graphene, carbon nanotubes, or carbon fiber. In some embodiments, a mass ratio of the positive active material, the conductive agent, and the binder in the positive active material layer may be (70 to 98):(1 to 15):(1 to 15). Understandably, the foregoing is merely an example, and the positive active material layer may adopt any other appropriate material, thickness, and mass ratio.

In some embodiments, the separator includes at least one of polyethylene, polypropylene, polyvinylidene fluoride, polyethylene terephthalate, polyimide, or aramid fiber. For example, the polyethylene includes at least one of high-density polyethylene, low-density polyethylene, or ultra-high-molecular-weight polyethylene. Especially the polyethylene and the polypropylene are highly effective in preventing short circuits, and improve stability of the battery through a turn-off effect. In some embodiments, the thickness of the separator is within a range of approximately 5 μm to 500 μm.

In some embodiments, a porous layer may be further included in a surface of the separator. The porous layer is disposed on at least one surface of a substrate of the separator. The porous layer includes inorganic particles and a binder. The inorganic particles is at least one selected from aluminum oxide (Al₂O₃), silicon oxide (SiO₂), magnesium oxide (MgO), titanium oxide (TiO₂), hafnium dioxide (HfO₂), tin oxide (SnO₂), ceria (CeO₂), nickel oxide (NiO), zinc oxide (ZnO), calcium oxide (CaO), zirconium oxide (ZrO₂), yttrium oxide (Y₂O₃), silicon carbide (SiC), boehmite, aluminum hydroxide, magnesium hydroxide, calcium hydroxide, or barium sulfate. In some embodiments, a diameter of a pore of the separator is within a range of approximately 0.01 μm to 1 μm. The binder in the porous layer is at least one selected from polyvinylidene difluoride, a vinylidene difluoride-hexafluoropropylene copolymer, a polyamide, polyacrylonitrile, polyacrylic ester, polyacrylic acid, sodium polyacrylate, sodium carboxymethyl cellulose, polyvinylpyrrolidone, polyvinyl ether, poly methyl methacrylate, polytetrafluoroethylene, or polyhexafluoropropylene. The porous layer on the surface of the separator can improve heat resistance, oxidation resistance, and electrolyte infiltration performance of the separator, and enhance adhesion between the separator and the electrode plate.

In some embodiments of this application, the electrode assembly of the electrochemical device is a jelly-roll electrode assembly, a folded electrode assembly, or a stacked electrode assembly.

In some embodiments, the electrochemical device includes, but is not limited to, a lithium-ion battery. In some embodiments, the electrochemical device may further include an electrolyte. The electrolyte may be one or more of a gel electrolyte, a solid-state electrolyte, and an electrolytic solution. The electrolytic solution includes a lithium salt and a nonaqueous solvent. The lithium salt is one or more selected from LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiSiF₆, LiBOB, or lithium difluoroborate. For example, the lithium salt is LiPF₆ because it provides a high ionic conductivity and improves cycle characteristics.

In some embodiments, the electrolytic solution includes at least one of the following compounds:

(a) propionate;

(b) an organic compound containing a cyano group;

(c) lithium difluorophosphate; and

(d)

[symbol]

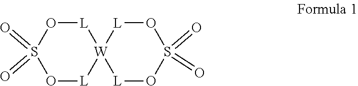

where

W is selected from

[symbol]

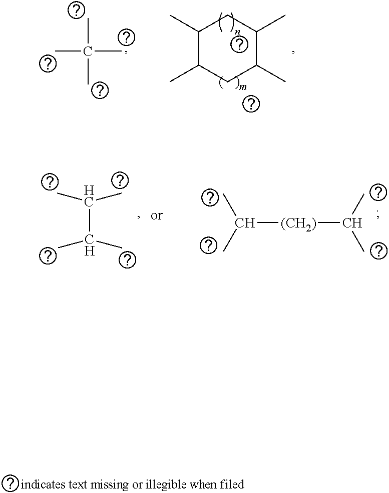

L is selected from a single bond or a methylene group;

m is an integer from 1 to 4;

n is an integer from 0 to 2; and

p is an integer from 0 to 6.

Propionate or an organic compound with a cyano group can significantly improve the cycle performance of electrochemical device. The added LiPO₂F₂ can increase the lithium ion transmission capability of the electrolytic solution, thereby improving the direct-current resistance of the electrochemical device. In this way, the capacity retention rate and the direct-current resistance (DCR) of the electrochemical device that adopts the electrolytic solution containing the foregoing compound are improved significantly.

In some embodiments, the propionate is a compound represented by the following chemical formula:

[symbol]

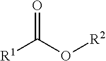

where

R¹ is an ethyl group or a haloethyl group; and

R² is a C₁ to C₆ alkyl group or a C₁ to C₆ haloalkyl group.

In some embodiments, the propionate includes at least one of methyl propionate, ethyl propionate, propyl propionate, butyl propionate, pentyl propionate, halogenated methyl propionate, halogenated ethyl propionate, halogenated propyl propionate, halogenated butyl propionate, or halogenated pentyl propionate. In some embodiments, a halogen group in the halogenated methyl propionate, halogenated ethyl propionate, halogenated propyl propionate, halogenated butyl propionate, and halogenated pentyl propionate includes at least one of a fluorine group (—F), a chlorine group (—Cl), a bromine group (—Br), or an iodine group (—I).

In some embodiments, based on the total weight of the electrolytic solution, the weight percent of the propionate is 10 wt % to 65 wt %. In some embodiments, based on the total weight of the electrolytic solution, the weight percent of the propionate is 15 wt % to 60 wt %. In some embodiments, based on the total weight of the electrolytic solution, the weight percent of the propionate is 30 wt % to to 50 wt %. In some embodiments, based on the total weight of the electrolytic solution, the weight percent of the propionate is 30 wt % to 40 wt %.

In some embodiments, the compound containing a cyano group includes at least one of: succinonitrile, glutaronitrile, adiponitrile, 1,5-dicyanopentane, 1,6-dicyanohexane, tetramethyl succinonitrile, 2-methyl glutaronitrile, 2,4-dimethyl glutaronitrile, 2,2,4,4-tetramethyl glutaronitrile, 1,4-dicyanopentane, 1,2-dicyanobenzene, 1,3-dicyanobenzene, 1,4-dicyanobenzene, ethylene glycol bis(propionitrile) ether, 3,5-dioxa-pimelonitrile, 1,4-bis(cyanoethoxy)butane, diethylene glycol bis(2-cyanoethyl) ether, triethylene glycol bis(2-cyanoethyl) ether, tetraethylene glycol bis(2-cyanoethyl)ether, 1,3-bis(2-cyanoethoxy)propane, 1,4-bis(2-cyanoethoxy)butane, 1,5-bis(2-cyanoethoxy)pentane, ethylene glycol bis(4-cyanobutyl)ether, 1,4-dicyano-2-butene, 1,4-dicyano-2-methyl-2-butene, 1,4-dicyano-2-ethyl-2-butene, 1,4-dicyano-2,3-dimethyl-2-butene, 1,4-dicyano-2,3-diethyl-2-butene, 1,6-dicyano-3-hexene, 1,6-dicyano-2-methyl-3-hexene, 1,3,5-pentanetricarbonitrile, 1,2,3-propanetricarbonitrile, 1,3,6-hexanetricarbonitrile, 1,2,6-hexanetricarbonitrile, 1,2,3-tris(2-cyanoethoxy)propane, 1,2,4-tris(2-cyanoethoxy)butane, 1,1,1-tris(cyanoethoxymethylene)ethane, 1,1,1-tris(cyanoethoxymethylene)propane, 3-methyl-1,3,5-tris(cyanoethoxy)pentane, 1,2,7-tris(cyanoethoxy)heptane, 1,2,6-tris(cyanoethoxy)hexane, or 1,2,5-tris(cyanoethoxy)pentane. In some embodiments, based on the total weight of the electrolytic solution, the weight percent of the compound containing a cyano group is 0.1 wt % to 15 wt %. In some embodiments, based on the total weight of the electrolytic solution, the weight percent of the compound containing a cyano group is 0.5 wt % to 10 wt %. In some embodiments, based on the total weight of the electrolytic solution, the weight percent of the compound containing a cyano group is 1 wt % b to 8 wt %. In some embodiments, based on the total weight of the electrolytic solution, the weight percent of the compound containing a cyano group is 3 wt % to 5 wt %.

In some embodiments, based on the total weight of the electrolytic solution, the weight percent of the lithium difluorophosphate is 0.01 wt % to 15 wt %. In some embodiments, based on the total weight of the electrolytic solution, the weight percent of the lithium difluorophosphate is 0.05 wt % to 12 wt %. In some embodiments, based on the total weight of the electrolytic solution, the weight percent of the lithium difluorophosphate is 0.1 wt % to 10 wt %. In some embodiments, based on the total weight of the electrolytic solution, the weight percent of the lithium difluorophosphate is 0.5 wt % to 8 wt %. In some embodiments, based on the total weight of the electrolytic solution, the weight percent of the lithium difluorophosphate is 1 wt % to 5 wt %. In some embodiments, based on the total weight of the electrolytic solution, the weight percent of the lithium difluorophosphate is 2 wt % to 4 wt %.

In some embodiments, the compound represented by Formula I includes at least one of the following compounds:

[symbol]

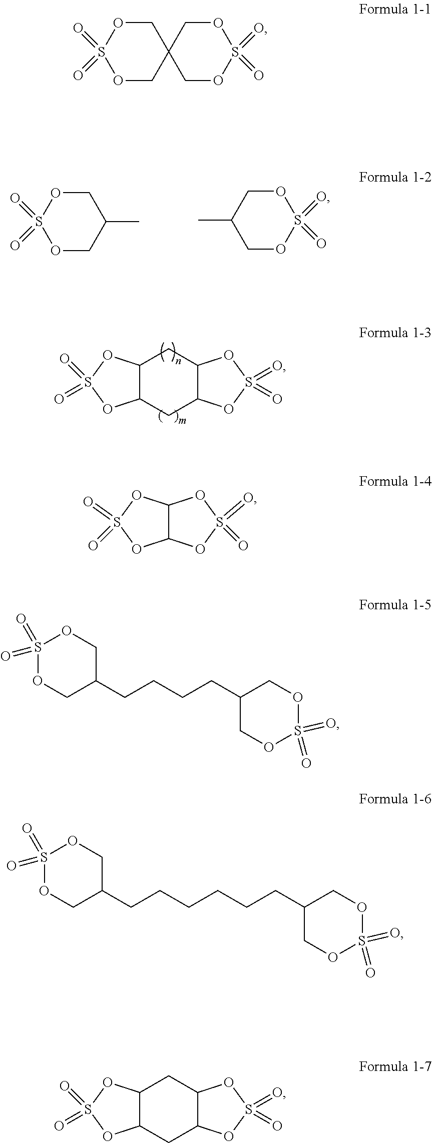

where m is an integer from 1 to 4; n is an integer from 0 to 2; and p is an integer from 0 to 6.

In some embodiments of this application, using a lithium-ion battery as an example, the lithium-ion battery is prepared by the following steps: winding, folding, or stacking a positive electrode plate, a separator, and a negative electrode plate sequentially into an electrode assembly, putting the electrode assembly into a package such as an aluminum plastic film ready for sealing, injecting an electrolytic solution, and performing chemical formation and sealing. Then a performance test is performed on the prepared lithium-ion battery.

A person skilled in the art understands that the method for preparing the electrochemical device (for example, the lithium-ion battery) described above is merely an example. To the extent not departing from the content disclosed herein, other methods commonly used in the art may be used.

An embodiment of this application further provides an electronic device containing the electrochemical device. The electronic device according to the embodiments of this application is not particularly limited, and may be any electronic device known in the prior art. In some embodiments, the electronic device may include, but is not limited to, a notebook computer, a pen-inputting computer, a mobile computer, an e-book player, a portable phone, a portable fax machine, a portable photocopier, a portable printer, a stereo headset, a video recorder, a liquid crystal display television set, a handheld cleaner, a portable CD player, a mini CD-ROM, a transceiver, an electronic notepad, a calculator, a memory card, a portable voice recorder, a radio, a backup power supply, a motor, a car, a motorcycle, a power-assisted bicycle, a bicycle, a lighting appliance, a toy, a game machine, a watch, an electric tool, a flashlight, a camera, a large household battery, a lithium-ion capacitor, and the like.

Some specific embodiments and comparative embodiments are enumerated below to give a clearer description of this application, using a lithium-ion battery as an example.

### Embodiment 1

Preparing a positive electrode plate: Dissolving lithium cobalt oxide as a positive active material, conductive carbon black as a conductive agent, and polyvinylidene difluoride (PVDF) as a binder at a weight ratio of 95:2:3 in an N-methyl-pyrrolidone (NMP) solution to form a positive slurry. Using a 12 μm-thick aluminum foil as a positive current collector, coating the positive current collector with the positive slurry in an amount of 18.37 mg/cm², and performing drying, cold pressing, and cutting to obtain a positive electrode plate.

Preparing a negative electrode plate: Dissolving the compound 1 and conductive carbon black at a weight ratio of 50:50 in deionized water to form a bonding layer slurry. Using a 12 μm-thick copper foil as a negative current collector, coating the negative current collector with the bonding layer slurry and performing drying to obtain a bonding layer, where the weight X of the bonding layer per unit area is 2×10⁻⁴ mg/mm².

Dissolving artificial graphite, silicon-based material SiO, conductive carbon black, polyacrylic acid (PAA), and sodium carboxymethyl cellulose at a weight ratio of 83.5:10:1:5:0.5 in deionized water to form a negative active material layer slurry. Coating the bonding layer with the negative active material layer slurry in an amount of 9.3 mg/cm², and performing drying and cutting to obtain a negative electrode plate.

Preparing a separator: Using 9 μm-thick polyethylene (PE) as a substrate of the separator, coating both sides of the substrate of the separator with a 2 μm-thick aluminum oxide ceramic layer. Finally, coating 2.5 mg of polyvinylidene difluoride (PVDF) as a binder onto both sides that have been coated with the ceramic layer, and performing drying.

Preparing an electrolytic solution: Adding LiPF₆ into a nonaqueous organic solvent in an environment in which a water content is less than 10 ppm, where the weight ratio between ingredients of the nonaqueous organic solvent is: propylene carbonate (PC):ethylene carbonate (EC):diethyl carbonate (DEC)=1:1:1, and the concentration of the LiPF₆ is 1.15 mol/L. Mixing the solution evenly to obtain an electrolytic solution.

Preparing a lithium-ion battery: stacking the positive electrode plate, the separator, and the negative electrode plate sequentially so that the separator is located between the positive electrode plate and the negative electrode plate to serve a function of separation, and winding the stacked materials to obtain an electrode assembly; Putting the electrode assembly in an aluminum plastic film that serves as an outer package, dehydrating the electrode assembly under 80° C., injecting the electrolytic solution, and performing sealing; and performing steps such as chemical formation, degassing, and edge trimming to obtain a lithium-ion battery.

The steps in the embodiments and comparative embodiments are the same as those in Embodiment 1 except changed parameter values.

In Comparative Embodiment 1, the negative electrode plate does not include the bonding layer, and the negative active material layer is directly coated on the negative current collector. Other conditions are the same as those in Embodiment 1.

In Embodiments 2 to 4 and Embodiments 9 to 10, the weight X of the bonding layer per unit area of the negative current collector is different from that in Embodiment 1, and the bonding force K between the negative current collector and the bonding layer is different from that in Embodiment 1.

In Embodiments 5 to 8, the type of the copolymer in the bonding layer and the weight X of the bonding layer per unit area of the negative current collector are different from those in Embodiment 1, and the bonding force K between the negative current collector and the bonding layer is different from that in Embodiment 1. The copolymer adopted in Embodiment 5 is compound 2, the copolymer adopted in Embodiment 6 is compound 3, the copolymer adopted in Embodiment 7 is compound 4, and the copolymer adopted in Embodiment 8 is compound 5.

In Comparative Embodiment 2, no copolymer is contained, and the weight X of the bonding layer per unit area of the negative current collector is different from that in Embodiment 1.

In Embodiments 11 to 17, the weight X of the bonding layer per unit area of the negative current collector and the capacity C per unit area of the negative active material layer are different from those in Embodiment 1.

In Embodiments 18 to 22, the bonding force K between the negative current collector and the bonding layer as well as the resistance (R₁-R₂) of the bonding layer are different from those in Embodiment 1.

In Embodiments 23 to 27, the adopted copolymer, the bonding force K between the negative current collector and the bonding layer, and the resistance (R₁-R₂) of the bonding layer are different from those in Embodiment 1. Embodiment 23 adopts the settings of Embodiment 2, Embodiment 24 adopts the settings of Embodiment 3, Embodiment 25 adopts the settings of Embodiment 4, Embodiment 26 adopts the settings of Embodiment 5, and Embodiment 27 adopts the settings of Embodiment 5.

Additional additives are added in the electrolytic solution in Embodiments 28 to 55 in comparison with Embodiment 1.

In addition, some parameter values of the copolymer are shown in Table 1 below:

TABLE 1

| | | Molar ratio | Molar ratio | Weight-average | Average | Swelling | |
|---|---|---|---|---|---|---|---|
| | Average | of propylene | of ethylene | molecular | particle diameter | degree in diethyl | Softening |
| Copolymer | isotacticity | monomer | monomer | weight | (μm) | carbonate | point |
| Compound 1 | 75% | 36% | 64% | 120000 | 11 | 35% | 86 |
| Compound 2 | 40% | 54% | 46% | 50000 | 9.8 | 23% | 83 |
| Compound 3 | 55% | 70% | 30% | 6400 | 4.4 | 28% | 87 |
| Compound 4 | 60% | 32% | 68% | 98000 | 20 | 20% | 80 |
| Compound 5 | 20% | 65% | 35% | 8000 | 35 | 32% | 79 |

The following describes the test method of each parameter in this application.

Method for Testing the Cycle Capacity Retention Rate:

Charging a lithium-ion battery at a constant current of 1 C under 45° C. until the voltage reaches 4.45 V, then charging the battery at a constant voltage of 4.45 V until the current reaches 0.05 C, and then discharging the battery at a constant current of 1 C until the voltage reaches 3.0 V, thereby completing a first cycle. Performing 200 cycles on the lithium-ion battery under the foregoing conditions. “1 C” is a current value at which the capacity of the battery can be fully discharged within 1 hour. Calculating the capacity retention rate of the lithium-ion battery after the cycles by using the following formula:

Cycle capacity retention rate=(200^{th}-cycle discharge capacity/first-cycle discharge capacity)×100%.

Method for Testing the Thickness Expansion Rate:

Charging a lithium-ion battery at a constant current of 1 C under 45° C. until the voltage reaches 4.45 V, then charging the battery at a constant voltage of 4.45 V until the current reaches 0.05 C, measuring the thickness of the lithium-ion battery by using a 500 g parallel plate gauge (PPG), and then discharging the battery at a constant current of 1 C until the voltage reaches 3.0 V, thereby completing a first cycle. Performing 200 cycles on the lithium-ion battery under the foregoing conditions. Calculating the thickness expansion rate of the lithium-ion battery after the cycles by using the following formula:

Thickness expansion rate=((thickness of the lithium-ion battery after 200 cycles−thickness of the lithium-ion battery after the first cycle)/thickness of the lithium-ion battery after the first cycle))×100%.

Method for Testing the Bonding Strength K (Unit: N/m) Between the Negative Current Collector and the Bonding Layer:

Cutting, at a room temperature, a current collector coated with a bonding layer into a strip that is 15 mm in width L and 20 cm in length. Using strong double-sided tape to stick the side coated with the bonding layer onto a test mold (a strip-shaped metal block), and using a GoTech tensile testing machine to pull the current collector by exerting a constant tensile force (the direction of the tensile force is parallel to the test mold), and recording the value of the tensile force F after the tensile force is stabilized. Calculating the thickness expansion rate of the lithium-ion battery after the cycles by using the following formula:

Bonding force K=stabilized tensile force F/width L of the negative current collector.

Method for testing the resistance R₁ of the bonding layer and the negative current collector and the resistance R₂ of the negative current collector:

Cutting, at a room temperature, a negative current collector coated with the bonding layer and an uncoated negative current collector into square specimens of approximately 6 cm×8 cm. Putting the specimen onto a test bench to ensure that the specimen completely covers the round hole of the mold (using a film resistance tester manufactured by Yuanneng Technology). The air pressure is 0.7 MPa and the exerted pressure is 0.4 T. Recording the measured resistance values R₁ and R₂.

Method for Testing the Direct-Current Resistance (DCR):

Adjusting the to-be-tested lithium-ion battery to a specified state of charge (SOC) (in this application, 50% SOC) at a room temperature, discharging the battery for a short time (in this application, 1 second) at a specified current density I (in this experiment, 1 C), and recording the voltages V₁ and V₂ of the lithium-ion battery before the discharge and after the discharge respectively. Calculating the DCR by using the following formula.

DCR=(V₁−V₂)/I.

Table 2 shows parameters and evaluation results in Embodiments 1 to 4, Embodiments 9 to 10, and Comparative Embodiment 1.

TABLE 2

| | | | | | Cycle capacity | Thickness |
|---|---|---|---|---|---|---|
| | Copolymer | X | K | X/K | retention rate | expansion rate |
| Comparative | / | / | / | / | 72% | 18.2% |
| Embodiment 1 | | | | | | |
| Embodiment 1 | Compound 1 | 2 | 12 | 0.167 | 81% | 15.1% |
| Embodiment 2 | Compound 1 | 2.3 | 15 | 0.153 | 84% | 14.2% |
| Embodiment 3 | Compound 1 | 2.8 | 15 | 0.187 | 82% | 15.1% |
| Embodiment 4 | Compound 1 | 4.7 | 42 | 0.112 | 87% | 11.2% |
| Embodiment 9 | Compound 1 | 21.2 | 12 | 1.77 | 53% | 15.2% |
| Embodiment 10 | Compound 1 | 2.4 | 31 | 0.077 | 47% | 12.6% |

“/” means nonexistence (the same applies below).

As can be seen from comparison between Embodiments 1 to 4 and Comparative Embodiment 1, by using a bonding layer containing a copolymer that includes a propylene monomer, the embodiments significantly improve both the cycle capacity retention rate and the thickness expansion rate of the lithium-ion battery.

In addition, as can be seen from comparison between Embodiments 1 to 4, when 0.1≤X/K≤0.75, as X/K increases, the cycle capacity retention rate of the lithium-ion battery shows a tendency to decrease, but the thickness expansion rate of the lithium-ion battery shows a tendency to increase. As can be seen from comparison between Embodiments 1 to 4 and Embodiments 9 to 10, when X/K is extraordinarily small or extraordinarily large, although the thickness expansion rate of the lithium-ion battery is improved to some extent, the cycle capacity retention rate of the lithium-ion battery is deteriorated to some extent.

Table 3 shows parameters and evaluation results in Embodiments 5 to 8 and Comparative Embodiment 1.

TABLE 3

| | | | | | Cycle capacity | Thickness |
|---|---|---|---|---|---|---|
| | Copolymer | X | K | X/K | retention rate | expansion rate |
| Comparative | / | / | / | / | 72% | 18.2% |
| Embodiment 1 | | | | | | |
| Embodiment 5 | Compound 2 | 5.1 | 32 | 0.159 | 85% | 15.5% |
| Embodiment 6 | Compound 3 | 6.5 | 23 | 0.283 | 82% | 15.9% |
| Embodiment 7 | Compound 4 | 11.4 | 26 | 0.438 | 74% | 16.9% |
| Embodiment 8 | Compound 5 | 14 | 22 | 0.636 | 73% | 17.7% |

As can be seen from comparison between Embodiments 5 to 8 and Comparative Embodiment 1, by using a bonding layer containing a copolymer that is other than compound 1 and that includes a propylene monomer, the embodiments also significantly improve the cycle capacity retention rate and the thickness expansion rate of the lithium-ion battery.

Table 4 shows parameters and evaluation results in Embodiments 11 to 17 and Comparative Embodiment 2.

TABLE 4

| | | | | | Cycle capacity | DCR |
|---|---|---|---|---|---|---|
| | Copolymer | X | C | X/C | retention rate | (mΩ) |
| Comparative | / | 10 | 0.031 | 352.58 | 82% | 60.848 |
| Embodiment 2 | | | | | | |
| Embodiment 11 | Compound 1 | 0.14 | 0.043 | 3.26 | 88% | 38.116 |
| Embodiment 12 | Compound 1 | 2.8 | 0.057 | 49.12 | 92% | 39.666 |
| Embodiment 13 | Compound 1 | 4.6 | 0.063 | 73.02 | 85% | 41.459 |
| Embodiment 14 | Compound 1 | 4.7 | 0.064 | 73.44 | 82% | 38.999 |
| Embodiment 15 | Compound 1 | 5.1 | 0.092 | 55.43 | 85% | 38.552 |
| Embodiment 16 | Compound 1 | 6.5 | 0.051 | 127.45 | 87% | 46.666 |
| Embodiment 17 | Compound 1 | 9.6 | 0.031 | 309.68 | 83% | 54.234 |

As can be seen from comparison between Embodiments 11 to 17 and Comparative Embodiment 2, by using a bonding layer containing a copolymer that includes a propylene monomer, the embodiments improve the cycle capacity retention rate of the lithium-ion battery to some extent, and improve the direct-current resistance of the lithium-ion battery significantly. In addition, when 3≤X/C≤350, as X/C increases, the cycle capacity retention rate of the lithium-ion battery increases at the beginning, and then decreases, and then increases again, and the direct-current resistance of the lithium-ion battery shows a tendency to increase.

Table 5 shows parameters and evaluation results in Embodiments 18 to 27.

TABLE 5

| | | | | | | | Cycle capacity | Thickness |
|---|---|---|---|---|---|---|---|---|
| | Copolymer | K | R₁ | R₂ | R₁ − R₂ | K/(R₁ − R₂) | retention rate | expansion rate |
| Embodiment 18 | Compound 1 | 20 | 15.2 | 1.3 | 13.9 | 1.44 | 77.8% | 10.1% |
| Embodiment 19 | Compound 1 | 12 | 14.5 | 2.6 | 11.9 | 1.01 | 80.2% | 19.3% |
| Embodiment 20 | Compound 1 | 15 | 29.2 | 4.7 | 24.5 | 0.61 | 81.0% | 14.1% |
| Embodiment 21 | Compound 1 | 15 | 7.4 | 5.8 | 1.6 | 9.38 | 79.4% | 9.8% |
| Embodiment 22 | Compound 1 | 30 | 11.7 | 7.2 | 4.5 | 6.67 | 80.2% | 19.3% |
| Embodiment 23 | Compound 2 | 28 | 58.8 | 7.7 | 51.1 | 0.55 | 74.1% | 10.1% |
| Embodiment 24 | Compound 3 | 32 | 15.3 | 14.1 | 1.2 | 26.67 | 90.4% | 11.1% |
| Embodiment 25 | Compound 4 | 39 | 19.5 | 18.8 | 0.7 | 55.71 | 50.2% | 15.9% |
| Embodiment 26 | Compound 5 | 34 | 42 | 30 | 12 | 2.83 | 81.5% | 13.2% |
| Embodiment 27 | Compound 5 | 30 | 92.9 | 49.1 | 43.8 | 0.68 | 83% | 10.9% |

As can be seen from Table 5, as K/(R₁-R₂) increases, the capacity retention rate of the lithium-ion battery shows a tendency to decrease first and then increase. As K/(R₁-R₂) increases, the thickness expansion rate of the electrochemical device shows a tendency to increase first and then decrease.

Table 6 shows parameters and evaluation results in Embodiments 28 to 55 and Embodiment 1.

TABLE 6

| | | Organic compound | | Compound | | |
|---|---|---|---|---|---|---|
| | Propionate | containing a cyano | LiPO₂F₂ | represented by | Cycle capacity | DCR |
| | (20 wt %) | group (2 wt %) | (0.5 wt %) | Formula 1 (1 wt %) | retention rate | (mΩ) |
| Embodiment 1 | / | / | / | / | 81% | 50.591 |
| Embodiment 28 | Propyl | / | / | / | 89 | 39.165 |
| | propionate | | | | | |
| Embodiment 29 | Ethyl | / | / | / | 88% | 38.665 |
| | propionate | | | | | |
| Embodiment 30 | /' | Adiponitrile | / | / | 83% | 39.659 |
| Embodiment 31 | / | Succinonitrile | / | / | 83% | 42.142 |
| Embodiment 32 | / | 1,3,6-hexanetricarbonitrile | / | / | 84% | 39.916 |
| Embodiment 33 | / | Ethylene glycol bis(2-cyano- | / | / | 82% | 40.701 |
| | | ethyl) ether | | | | |
| Embodiment 34 | / | / | LiPO₂F₂ | | 86% | 33.43 |
| Embodiment 35 | / | / | / | Formula 1-1 | 83% | 40.583 |
| Embodiment 36 | / | / | / | Formula 1-2 | 83% | 39.916 |
| | | | | (p = 1) | | |
| Embodiment 37 | / | / | / | Formula 1-4 | 84% | 42.015 |
| Embodiment 38 | Propyl | Adiponitrile | / | / | 88% | 38.253 |
| | propionate | | | | | |
| Embodiment 39 | Propyl | Succinonitrile | / | / | 88% | 39.527 |
| | propionate | | | | | |
| Embodiment 40 | Propyl | 1,3,6-hexanetricarbonitrile | / | / | 89% | 39.671 |
| | propionate | | | | | |
| Embodiment 41 | Propyl | Ethylene glycol bis(2-cyano- | / | / | 87% | 39.291 |
| | propionate | ethyl) ether | | | | |
| Embodiment 42 | Propyl | 1,2,3-tris(2-cyanoethoxy) | / | / | 91% | 39.805 |
| | propionate | propane | | | | |
| Embodiment 43 | Propyl | / | LiPO₂F₂ | / | 88% | 32.124 |
| | propionate | | | | | |
| Embodiment 44 | Propyl | / | / | Formula 1-1 | 88% | 40.096 |
| | propionate | | | | | |
| Embodiment 45 | Propyl | / | / | Formula 1 -2 | 89% | 40.591 |
| | propionate | | | (p = 1) | | |
| Embodiment 46 | Propyl | / | / | Formula 1-4 | 89% | 39.165 |
| | propionate | | | | | |
| Embodiment 47 | / | 1,3,6-hexanetricarbonitrile | LiPO₂F₂ | / | 84% | 32.665 |
| Embodiment 48 | / | 1,3,6-hexanetricarbonitrile | / | Formula 1-1 | 83% | 39.659 |
| Embodiment 49 | / | 1,3,6-hexanetricarbonitrile | / | Formula 1-2 | 83% | 37.991 |
| | | | | (p = 1) | | |
| Embodiment 50 | / | 1,3,6-hexanetricarbonitrile | / | Formula 1-4 | 84% | 37.33 |
| Embodiment 51 | / | 1,2,3-tris(2-cyanoethoxy) | / | Formula 1-1 | 82% | 39.131 |
| | | propane | | | | |
| Embodiment 52 | / | 1,2,3-tris(2-cyanoethoxy) | / | Formula 1-2 | 86% | 39.303 |
| | | propane | | (p = 1) | | |
| Embodiment 53 | / | 1,2,3-tris(2-cyanoethoxy) | / | Formula 1-4 | 83% | 43.268 |
| | | propane | | | | |
| Embodiment 54 | Propyl | 1,2,3-tris(2-cyanoethoxy) | LiPO₂F₂ | / | 90% | 37.991 |
| | propionate | propane | | | | |
| Embodiment 55 | Propyl | 1,2,3-tris(2-cyanoethoxy) | LiPO₂F₂ | Formula 1-4 | 95% | 31.33 |
| | propionate | propane | | | | |

As can be seen from comparison between Embodiments 28 to 55 and Embodiment 1, the additives such as propionate, an organic compound with a cyano group, and/or difluorophosphate that are added into the electrolytic solution can significantly improve the cycle capacity retention rate and the direct-current resistance of the electrochemical device. That is because the propionate or the organic compound with a cyano group can improve the formation of the SEI film on the surface of the negative electrode plate. The added difluorophosphate can increase the lithium ion transmission capability of the electrolytic solution, and improve the internal resistance of the electrochemical device.

What is described above is merely exemplary embodiments of this application and the technical principles thereof. A person skilled in the art understands that the scope of disclosure in this application is not limited to the technical solutions formed by a specific combination of the foregoing technical features, but also covers other technical solutions formed by arbitrarily combining the foregoing technical features or equivalents thereof, for example, a technical solution formed by replacing any of the foregoing features with a technical feature disclosed herein and serving similar functions.

What is claimed is:

1. A negative electrode plate, comprising:
a negative current collector;
a bonding layer comprising a copolymer, wherein monomers that form the copolymer comprise at least a propylene monomer; and
a negative active material layer, wherein the bonding layer is disposed between the negative current collector and the negative active material layer.

2. The negative electrode plate according to claim 1, wherein
0.1≤X/K≤0.75,
wherein, a weight of the bonding layer per unit area of the negative current collector is X×10⁻⁴ mg/mm², and a bonding force between the negative current collector and the bonding layer is K N/m.

3. The negative electrode plate according to claim 2, wherein 1≤X≤30.

4. The negative electrode plate according to claim 2, wherein 1≤X≤10.5.

5. The negative electrode plate according to claim 2, wherein 1≤K≤100.

6. The negative electrode plate according to claim 1, wherein
3≤X/C≤350,
wherein, a weight of the bonding layer per unit area of the negative current collector is X×10⁻⁴ mg/mm², and a capacity per unit area of the negative active material layer is C mAh/mm².

7. The negative electrode plate according to claim 5, wherein 3≤X/C≤100.

8. The negative electrode plate according to claim 1, wherein
0.2≤K/(R₁−R₂)≤100,
a bonding force between the negative current collector and the bonding layer is K N/m, a total resistance of the bonding layer and the negative current collector is R₁ mΩ·mm², and a resistance of the negative current collector is R₂ mΩ·mm².

9. The negative electrode plate according to claim 1, wherein the copolymer possesses at least one of the following characteristics:
(a) the propylene monomer accounts for 30 mol % to 95 mol % of an aggregate of the monomers that form the copolymer;
(b) the copolymer is particles, and an average particle diameter of the particles is 50 μm or less;
(c) a softening point of the copolymer is 70° C. to 90° C.;
(d) an isotacticity of the copolymer is 35% to 80%;
(e) a weight-average molecular weight of the copolymer is 500 to 1,000,000; and
(f) a swelling degree of the copolymer in diethyl carbonate is 40% or less.

10. The negative electrode plate according to claim 1, wherein the copolymer comprises a polar functional group, and the polar functional group comprises at least one selected from the group consisting of a hydroxyl group, an amino group, a carboxyl group and an ester group.

11. The negative electrode plate according to claim 1, wherein the monomers that form the copolymer further comprise at least one selected from the group consisting of ethylene, vinylidene difluoride, chloroethylene, butadiene, isoprene, styrene, acrylonitrile, ethylene oxide, propylene oxide, acrylate, vinyl acetate and caprolactone.

12. The negative electrode plate according to claim 1, wherein the negative active material layer comprises a silicon-based material, a percentage of a weight of the silicon-based material in a total weight of the negative active material layer is Y %, and 5≤Y≤95.

13. The negative electrode plate according to claim 1, wherein the bonding layer further comprises a conductive agent, and the conductive agent comprises at least one selected from the group consisting of carbon black, Ketjen black, graphene, carbon nanotubes and carbon fiber.

14. The negative electrode plate according to claim 11, wherein
0.1≤W/Y≤50,
wherein a resistance of the negative active material layer is W mΩ·mm².

15. An electrochemical device, comprising:
a positive electrode plate;
a negative electrode plate; and
a separator disposed between the positive electrode plate and the negative electrode plate, wherein
the negative electrode plate is the negative electrode plate according to claim 1.

16. The electrochemical device according to claim 14, wherein the electrochemical device further comprises an electrolytic solution, and the electrolytic solution comprises at least one of the following compounds:
(a) propionate;
(b) an organic compound containing a cyano group;
(c) lithium difluorophosphate; and
(d) [symbol] 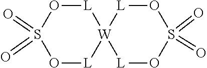
wherein
W is selected from [symbol] 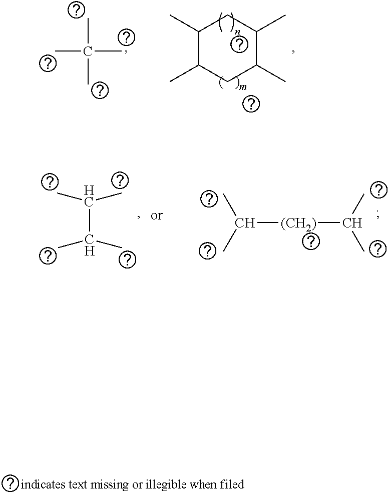
L is selected from a single bond or a methylene group;
m is an integer from 1 to 4;
n is an integer from 0 to 2; and
p is an integer from 0 to 6.

17. An electronic device, comprising an electrochemical device, the electrochemical device comprises a negative electrode plate, the negative electrode plate comprising:
a negative current collector;
a bonding layer comprising a copolymer, wherein monomers that form the copolymer comprise at least a propylene monomer; and
a negative active material layer, wherein the bonding layer is disposed between the negative current collector and the negative active material layer.

18. The electronic device according to claim 17, wherein
0.1≤X/K≤0.75,
wherein, a weight of the bonding layer per unit area of the negative current collector is X×10⁻⁴ mg/mm², and a bonding force between the negative current collector and the bonding layer is K N/m.

19. The electronic device according to claim 18, wherein 1≤X≤30.

20. The electronic device according to claim 18, wherein 1≤K≤100.
